(19) United States
(12) Patent Application Publication
(10) Pub. No.: US 2019/0303495 A1
(43) Pub. Date: Oct. 3, 2019

(54) SYSTEM AND METHOD FOR ENHANCING ENTITY PERFORMANCE

(71) Applicant: Mastercard International Incorporated, Purchase, NY (US)

(72) Inventors: Gautam Chopra, New Delhi (IN); Alan Gorenstein, Fairfield, CT (US); Daniel Harrison, Thornwood, NY (US)

(21) Appl. No.: 15/943,497

(22) Filed: Apr. 2, 2018

(51) Int. Cl. G06F 17/30; G06K 9/62

(52) U.S. Cl. CPC G06F 17/30604; G06K 9/6248; G06F 17/30598

(57) ABSTRACT

Systems and methods for enhancing entity performance include a resource manager in communication with a plurality of entities, the entities including one or more source acquirers and one or more resource issuers. The resource manager includes a processor, and a memory storing an analyzer having computer readable instructions that, when executed by the processor, operate to perform the following steps: organize the plurality of entities into a plurality of segments based on one or more parameters of the plurality of entities, differentiate each segment from other segments based on one or more differentiators, compare practices of an entity within a given segment to identify an action to enhance performance of the entity, and communicate the action to the entity. The parameters may include primary parameters that are extracted from a dataset, revised parameters that are extrapolated from the dataset, and then iteratively reduced until accurate segments are generated.

### BACKGROUND

As the digital age continues, more and more data regarding entity performance is generated. This data includes an ever-increasing number of variables that impact the determination of how well any given entity is performing. As such, it is increasingly difficult to determine what other entities to compare a given entity to in order to analyze the performance of the given entity.

### SUMMARY

Embodiments discussed herein resolve the above discussed problems and difficulties by grouping entities into appropriate segments and identifying the appropriate action to enhance an entity's performance. The segments are accurate in that the entities therein are grouped according to parameters, which may (e.g., in the case of a focus group or market) or may not (e.g., in the case of a cross-market grouping) be the same between all segments. The segments may be derived by extracting primary parameters from an initial dataset, extrapolating revised parameters from the dataset and in addition to the primary parameters, and then reducing the total number of revised parameters until a desired segmentation of the entities is obtained. Constraints may be included in this data processing to allow an accurate segmentation to occur that allows an entity to be compared to another entity in an accurate manner, even if not in the same or similar markets.

In a first aspect, a system for enhancing entity performance includes a resource manager in communication with a plurality of entities, the entities including one or more source acquirers and one or more resource issuers. In embodiments of the first aspect, the resource manager includes a processor, and a memory storing an analyzer having computer readable instructions that, when executed by the processor, operate to perform the following steps: organize the plurality of entities into a plurality of segments based on one or more parameters of the plurality of entities, differentiate each segment from other segments based on one or more differentiators, compare practices of an entity within a given segment to identify an action to enhance performance of the entity, and communicate the action to the entity.

In embodiments of the first aspect, the analyzer is a resource issue analyzer.

In embodiments of the first aspect, the analyzer is a source acquirer analyzer.

In embodiments of the first aspect, the differentiators are different from the parameters.

In embodiments of the first aspect, at least one of the differentiators is the same as at least one of the parameters.

In embodiments of the first aspect, the step of organizing the plurality of entities into a plurality of segments includes the sub-steps of: obtaining transaction data from a transaction database to identify the plurality of entities, extracting primary parameters associated with the entities, extrapolating revised parameters from the transaction data and in addition to the primary parameters.

In embodiments of the first aspect, the step of extracting primary parameters associated with the entities includes performing an exploratory data analysis algorithm.

In embodiments of the first aspect, the extrapolating revised parameters from the transaction data and in addition to the primary parameters includes performing a Cartesian algorithm.

In embodiments of the first aspect, the step of organizing the plurality of entities into a plurality of segments further includes reducing the revised parameter count.

In embodiments of the first aspect, the step of reducing the revised parameter count includes iteratively determining the Euclidean distance of each revised parameter until a desired number of parameters is determined.

In embodiments of the first aspect, the step of reducing the revised parameter count includes comparing each revised parameter to at least one constraint as defined by administrator interaction with the analyzer.

In a second aspect, a method for enhancing entity performance includes: extracting a plurality of primary parameters from transaction data associated with a plurality of entities; extrapolating revised parameters from the transaction data in addition to the primary parameters; organizing the plurality of entities into a plurality of segments based on the revised parameters; differentiating each segment from other segments based on one or more differentiators; comparing practices of an entity within a given segment to identify an action to enhance performance of the entity; and communicating the action to the entity.

In embodiments of the second aspect, the extracting primary parameters includes performing an exploratory data analysis algorithm.

In embodiments of the second aspect, the extrapolating revised parameters from the transaction data and in addition to the primary parameters includes performing a Cartesian algorithm.

In embodiments of the second aspect, the method further includes reducing the revised parameter count.

In embodiments of the second aspect, the reducing the revised parameter count includes iteratively determining the Euclidean distance of each revised parameter until a desired number of parameters is determined.

In embodiments of the second aspect, the reducing the revised parameter count includes comparing each revised parameter to at least one constraint as defined by administrator interaction with the analyzer.

In a third aspect, a non-transitory computer readable medium comprising computer executable instructions stored thereon executed by a processor to enhance performance of an entity, the instructions controlling the processor to: extract a plurality of primary parameters from transaction data associated with a plurality of entities; extrapolate revised parameters from the transaction data in addition to the primary parameters; iteratively reduce the revised parameters until a desired number of revised parameters is obtained; organize the plurality of entities into a plurality of segments based on the revised parameters; differentiate each segment from other segments based on one or more differentiators; compare practices of an entity within a given segment to identify an action to enhance performance of the entity; and communicate the action to the entity.

In embodiments of the third aspect, the iteratively reduce the revised parameter count includes instructions to iteratively determine the Euclidean distance of each revised parameter.

In embodiments of the third aspect, the iteratively reduce the revised parameter count includes instructions to compare each revised parameter to at least one constraint as defined by administrator interaction with the analyzer.

### BRIEF DESCRIPTION OF THE FIGURES

FIG. 1 depicts an example system for increasing entity performance, in embodiments.

FIG. 2 is an example diagram of entity segmentation and creation of the action to improve performance of one or more resource issuer of FIG. 1, in embodiments.

FIG. 3 depicts the primary issuer parameters list of FIG. 2 in further detail showing a matrix of parameters associated with each issuer in the resource issuer list, in embodiments.

FIG. 4 depicts the issuer practice list of FIG. 2 in further detail showing a matrix of parameters associated with each issuer in the resource issuer list, in embodiments.

FIG. 5 is an example diagram of entity segmentation and creation of the action to improve performance of one or more source acquirer of FIG. 1, in embodiments.

FIG. 6 depicts the primary source acquirer parameter list of FIG. 5 in further detail showing a matrix of parameters associated with each source acquirer in the source acquirer list, in embodiments.

FIG. 7 depicts the source acquirer practice list of FIG. 5 in further detail showing a matrix of parameters associated with each source acquirer in the source acquirer list, in embodiments.

FIG. 8 depicts a method for increasing entity performance, in embodiments.

FIG. 9 depicts a graph of four example segments that are differentiated according to two differentiators, in embodiments.

### DETAILED DESCRIPTION OF THE EMBODIMENTS

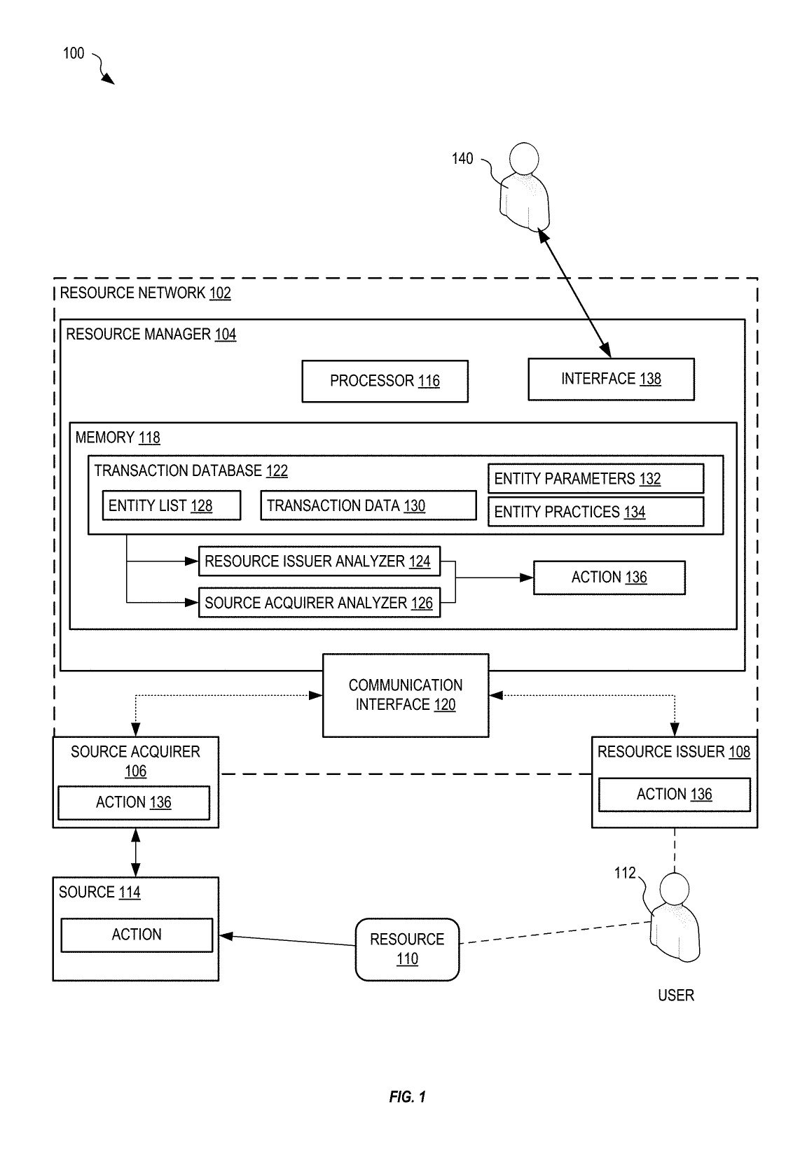

FIG. 1 depicts an example system 100 for enhancing entity performance, in embodiments. The system 100 includes a resource network 102 including a resource manager 104, a source acquirer 106, and a resource issuer 108. Although there is only shown a single resource manager 104, a single source acquirer 106, and a single resource issuer 108, it should be appreciated that there may be any number of such resource manager 104, source acquirer 106, and resource issuer 108 without departing from the scope hereof.

The resource manager 104 may represent one or more servers of: MasterCard®, Visa®, and so on, where the resource network 102 represents a four-party network such as the MasterCard® payment network or Visa® payment network, respectively. Although a four-party resource network 102 is shown, the concepts of the resource manager 104 may be used with three-party networks, such as handled by American Express®, for example.

In the resource network 102, a resource 110 may be issued to a user 112 from the resource issuer 108. The resource 110 may be any one or more of a debit card, credit card, charge card, gift card, electronic wallet service (such as MasterCard® MasterPass®), or the like. The user 112 may perform a transaction with a source 114 to obtain a good or service using the resource 110. Although there is only shown a single resource 110, a single user 112, and a single source 114, it should be appreciated that there may be any number of such resource 110, user 112, and source 114 without departing from the scope hereof.

The resource manager 104 may include a processor 116 in electrical communication with a memory 118, and a communication interface 120. The processor 116 may be any one or more microprocessors, computers, or other devices capable of executing computer readable instructions. The memory 118 may include one or more of volatile (e.g., RAM, DRAM, etc.) and non-volatile memory (e.g., ROM, NVRAM, magnetic tape, hard disk drive, optical disc, etc.). The memory 118 may store a transaction database 122, and one or both of a resource issuer analyzer 124 and a source acquirer analyzer 126. The communication interface 120 may operate according to any wired or wireless communication protocol such that any one or more of the resource manager 104, source acquirer 106, the resource issuer 108, the user 112, and the source 114 may communicate with each other.

Information regarding the associated entities in the system 100 is stored within the transaction database 122 of the resource manager 104. The transaction database 122 may include a variety of data including, but not limited to, an entity list 128, transaction data 130, entity parameters 132, and entity practices 134. The transaction database 122, although shown as stored within the memory 118, may also be stored remotely from the memory 118 and downloaded for analysis by one or both of the resource issuer analyzer 124 and the source acquirer analyzer 126. For example, the transaction database 122 may be data from the MasterCard transaction database.

In embodiments, the entity list 128 includes a listing of some or all entities associated with the system 100. For example, the entity list 128 may include one or more of the source acquirer(s) 106 in communication with the resource manager 104, the resource issuers 108 in communication with the resource manager 104, each user 112 associated with the resource issuer 108, each resource 110 associated with each user 112, and each source 114 associated with each source acquirer 106. A source acquirer (e.g., source acquirer 106) as used herein may be an institution that accepts and processes transactions made with resource 110 (or other resources associated with the resource manager (e.g., resource manager 104). A resource issuer (e.g., resource issuer 108) as used herein may be an institution that issues resources (e.g. resource 110) on behalf of the resource manager (e.g., resource manager 104; or institution hosting the resource manager).

In embodiments, the transaction data 130 includes information regarding transactions between entities within the entity list 128 (or other entities not necessarily listed in the entity list 128). For example, the transaction data 130 may include transactions between the user 112 and the source 114 using the resource 110. As another example, the transaction data 130 may include data regarding acquisition requirements between the source acquirer 106 and the source 114 (such as transaction fees, monthly fees, etc.). As another example, the transaction data 130 may include data regarding acquisition requirements between the resource issuer 108 and the user 112 (such as yearly dues, late payment information, interest rates, etc.). The transaction data 130 may be transmitted to the resource manager from any one or more of the source acquirer 106, the resource issuer 108, the user 112, and the source 114 via the communication interface 120.

In embodiments, the entity parameters 132 include information about the entities in the entity list 128 that are not associated with specific transactions between entities within the system 100. For example, the entity parameters 132 may include ratio of credit resource portfolio to debit (or prepaid) resource portfolio. As another example, the entity parameters 132 may include information regarding groups of transactions, such as information regarding the type of users 112 associated with a given resource issuer 108, or the type of sources 114 associated with a given source acquirer 106. Alternatively or additionally, the entity parameters 132 include information derived from the transaction data 130. For example, the entity parameters 132 may include, but are not limited to, any one or more of cross border decline rate, cross border ticket size, decline rate, ticket size (and/or a statistical variant thereof such as average, mean, max, min, etc.), diversity of products obtained by the user 112 from one or more sources 114, ecommerce percentage, cross border volume, cross border size, maestro focus, etc.

In embodiments, the entity practices 134 include actions taken by entities within the system 100. For example, the entity practices 134 may include advertising practices of the source acquirer 106 and/or the resource issuer 108. As another example, the entity practices 134 may include information regarding the demographics of the users 112 obtained by a given resource issuer 108 (such as age, gender, location, type of purchases, etc.). As another example, the entity practices 134 may include salesforce information (e.g., size of sales team, sales team budgets, sales team markets, etc.) of the source acquirer 106 and/or the resource issuer 108.

One or both of the resource issuer analyzer 124 and the source acquirer analyzer 126 include computer readable instructions that when executed by the processor 116 operate to perform the functionality described herein. For example, one or both of the resource issuer analyzer 124 and the source acquirer analyzer 126 extract the necessary information from the transaction database 122 and generate an action 136. In embodiments, the action 136 is a determination of an entity practice that the resource issuer 108 and/or source acquirer 106 should take in order to improve performance thereof. The action 136 may then be transmitted, via the communication interface 120, to the source acquirer 106 and/or resource issuer 108.

The resource issuer analyzer 124 and the source acquirer analyzer 126 provide an improved data analysis system over prior data analysis. The resource issuer analyzer 124 and the source acquirer analyzer 126 process the data within the transaction database 122 to segment the entities within the entity list 128 such that appropriate comparison of entities can be made. Not only are entities within the same markets (e.g. the same geographical location, the same target customers, etc.) capable of being compared, but with the creation of segments, as discussed below, the system 100 is able to compare entities across markets (such as across international or geographical borders). The identified segments are unique and impartial groupings of entities that make business sense. Each segment has its own unique characteristics, needs, and key performance indicators (KPI's).

In embodiments, the resource manager 104 further includes an interface 138 that allows an administrator 140 to interact with one or more of the transaction database 122, the resource issuer analyzer 124, and the source acquirer analyzer 126. The interface 138 may be a web portal, or may be a display and input device (such as a computer, mobile, or other application) that allows the administrator 140 to control operation of the resource issuer analyzer 124 and/or the source acquirer analyzer 126. For example, the administrator 140 may access the resource manager 104 to set thresholds and constraints associated with the determination of the action 136. The administrator 140 may be a market expert associated with the resource manager 104, or may be any person associated with the source acquirer 106 or resource issuer 108.

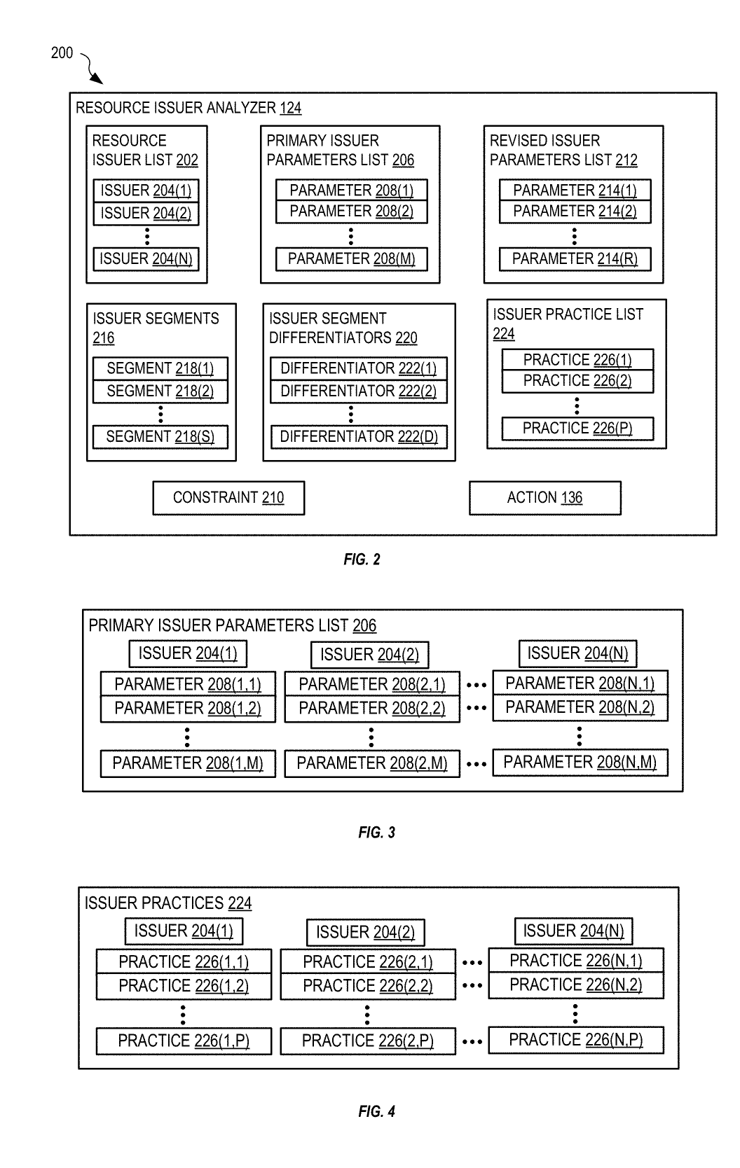

FIG. 2 is an example diagram 200 of entity segmentation and creation of the action 136 to improve performance of one or more resource issuers 108, of FIG. 1, in embodiments. The resource issuer analyzer 124 extracts, from the transaction database 122, a resource issuer list 202. The resource issuer list 202 includes issuers from the entity list 128. The resource issuer list 202 may include all issuers within the entity list 128, or may include issuers having certain parameters and thresholds as set by administrator (e.g., administrator 140) interaction with the resource issuer analyzer 124. As such, the resource issuer list 202 includes a list of issuers 204(1)-204(N).

The resource issuer analyzer 124 further determines a primary issuer parameter list 206 including a plurality of issuer parameters 208(1)-208(M) associated with each of the issuers 204 in the resource issuer list 202. FIG. 3 depicts the primary issuer parameters list 206 in further detail showing a matrix of parameters 208(1)-208(M) associated with each issuer 204(1)-204(N) in the resource issuer list 202. In FIG. 3, the denotation parameter 208(1,1) indicates the first parameter for the first issuer. The denotation parameter 208(N,M) indicates the Mth parameter for the Nth issuer.

In embodiments, the resource issuer analyzer 124 determines primary parameters list 206 by extracting the parameters 208 from the transaction database 122, such as directly from the transaction data 130 and/or the entity parameters 132. For example, an administrator (e.g., administrator 140) may set one or more constraints 210 that control identification of the parameters 208. The constraints 210 may include key parameters that are known to be key performance indicators, thresholds for when a parameter is important or not, etc. The constraints 210 may thus be used to create the primary parameters list 206, as well as extrapolating additional parameters as discussed below. In embodiments, the resource issuer analyzer 124 determines the primary parameters list 206 by extracting the parameters 208 from the transaction data 130 using a statistical model. For example, the statistical model may be an exploratory data analysis (EDA). The statistical model may use one or more of univariate, bivariate, and multivariate approaches. The resource issuer analyzer 124 may process the transaction data 130 according to the EDA to identify parameters that are listed in the entity parameters 132 and/or other parameters that may not be listed.

In embodiments, the resource issuer analyzer 124 may then extrapolate and/or reduce the number of parameters 208 in the primary issuer parameters list 206 to generate a revised issuer parameters list 212. The revised issuer parameters list 212 may have a number of revised parameters 214(1)-214(R) that are used for generation of a segment list 216 based thereon. In embodiments, the number R of revised parameters 214 may be less than, equal to, or greater than the number M of parameters 208. For example, the resource issuer analyzer 124 may perform a Cartesian algorithm to extrapolate revised parameters 214 that are additional to the primary parameters 208 and extrapolated from the raw data within the transaction database 122. To illustrate an example, consider the business scenario of “payments made”, where issuer parameters list 206 includes two primary parameters 208 of “spending” and “transactions”. Over a million additional parameters may be extracted from these two primary parameters 208 based on business scenarios like cross border, domestic, card present, card not present, and weekday versus weekend, approved versus declined. The extrapolation may include combining various primary parameters in combination by observing the contribution of individual parameter in the combined value. This further leads to observing the combination of combined results rather than studying a one to one impact.

The extrapolation of revised parameters may, in certain embodiments, result in too many revised parameters 214. As such, after the revised parameters 214 are extrapolated from the primary parameters 208, an iterative process may proceed to reduce the number of revised parameters 214 to a desired amount. As such, the iterative process may analyze each of the revised parameters 214 to determine its mathematical and/or business relevance to the determination of issuer segments 216. To determine if a parameter 208, or the revised parameter 214, is relevant according to business importance, the resource issuer analyzer 124 may compare the parameter 208, or the revised parameter 214, to constraints 210 (e.g., by reviewing cross border versus domestic parameters, resource present versus resource not present, etc,) to determine if the parameter 208, or the revised parameter 214, should be considered when determining the segments 216. To determine if a parameter 208, or a revised parameter 214, is relevant according to mathematical importance, the resource issuer analyzer 124 may calculate the Euclidian distance of each parameter 208, or revised parameter 214, in isolation. For example, the resource issuer analyzer 124 may determine the revised parameter 214 with the minimum 1−r2=˜ as a parameter cluster representative. The 1−r₂˜o may be defined as 1−r2=. . . =(1−r . . . , . . . 2)(1−r . . . , . . . :). The desired output may obtain the cluster representative to be as closely correlated to its own cluster (r0˜0.2−∓1) and as uncorrelated to the nearest cluster (r . . . ˜0.2−∓0). Thus, the optimal representative of a cluster is a variable where 1−r2. . . tends to zero. The revised parameters 214 may be determined as the cluster representatives after the Euclidean distance of each revised parameter 214 is calculated. If further reduction is necessary, additional mathematical and business relevancy determinations may be made in an iterative process.

Once the desired number of revised parameters 214 is obtained, the resource issuer analyzer 124 may create a plurality of segments 218 that group each of the issuers 204 into one or more different segments 218 according to their associated revised issuer parameters 214. In embodiments, the segments 218 are created according to a k-means learning algorithm. For example, initial centroids within the revised parameters 214 are chosen randomly. The centroid may be the mean of the points in a given cluster. The resource issuer analyzer 124 then determines closeness of each point as determined by one or more of Euclidean distance, cosine similarity, correlation, etc. The k-means then converge for a common similarity measures (such as sum of squared error (SSE). The k-means convergence may be iteratively repeated until a desired convergence of segments 218 is achieved. Each segment 218 may be based on the same revised parameters 214 respectively (e.g., rankings of transactions, credit vs debit profile, customer numbers, etc.), or different ones of the revised parameters 214 may alter each segment 218 in a different way such that each segment 218 is based on different one or more of the parameters 214.

The above described functionality of the resource issuer analyzer 124 results in a plurality of segments 218(1)-218(S). These segments 218 improve the ability of the system 100 to analyze the raw data within the transaction database 122 to determine an appropriate and effective action 136 to produce to the given entity (e.g. the resource issuer 108). Once the issuers 204 are grouped according to the segments 218, any given issuer 204 can be compared to another issuer in the same segment 218, or in a different segment 218. This allows the resource issuer analyzer 124 to accurately compare issuers even if those issuers may be in different markets, or have different initiatives. For example, because of the segmentation described above, the resource issuer analyzer 124 may issue an action 136 for a given issuer 204 by comparing the given issuer 204 against another issuer 204 that is within a different geographical location (e.g. cross border initiatives).

To compare any given issuer in a given segment 218 (either against another issuer in the same segment, or another issuer(s) in another segment), the resource issuer analyzer 124 may use one or more of the differentiators 222(1)-222(D) from a list of issuer segment differentiators 220. The differentiators 222 may be the same or different than the revised parameters 214 and/or primary parameters 208. Once the segments 218 are differentiated according to the differentiator(s) 222, the resource issuer analyzer 124 may analyze an issuer practice list 224, including a listing of issuer practices 226(1)-226(P) for each issuer 204, to identify practice(s) of other issuers that can be used to determine the action 136 to recommend to a given issuer. FIG. 4 depicts the issuer practices list 224 in further detail showing a matrix of parameters 226(1)-226(P) associated with each issuer 204(1)-204(N) in the resource issuer list 202. In FIG. 4, the denotation practice 226(1,1) indicates the first practice for the first issuer. The denotation practice 226(N,P) indicates the Pth practice for the Nth issuer.

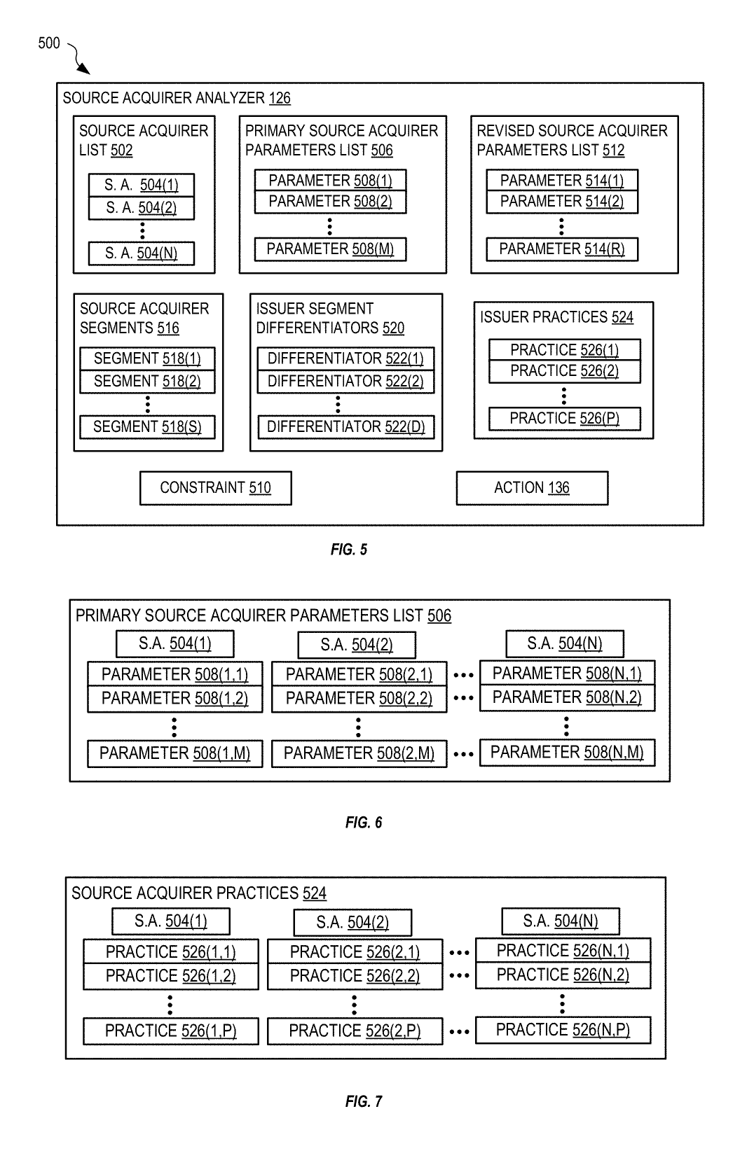

FIG. 5 is an example diagram 500 of entity segmentation and creation of the action 136 to improve performance of the source acquirer 106, of FIG. 1, in embodiments. The source acquirer analyzer 126 extracts, from the data within the transaction database 122, a source acquirer list 502. The source acquirer list 502 includes source acquirers from the entity list 128. The source acquirer list 502 may include all source acquirers within the entity list 128, or may include source acquirers having certain parameters and thresholds as set by administrator (e.g., administrator 140) interaction with the source acquirer analyzer 126. As such, the source acquirer list 502 includes a list of source acquirers 504(1)-504(N).

The source acquirer analyzer 126 further determines a primary source acquirer parameter list 506 including a plurality of source acquirer parameters 508(1)-508(M) associated with each of the source acquirers 504 in the source acquirer list 502. FIG. 6 depicts the primary source acquirer parameter list 506 in further detail showing a matrix of parameters 508(1)-508(M) associated with each source acquirer 504(1)-504(N) in the source acquirer list 502. In FIG. 6, the denotation parameter 508(1,1) indicates the first parameter for the first source acquirer. The denotation parameter 508(N,M) indicates the Mth parameter for the Nth source acquirer.

In embodiments, the source acquirer analyzer 126 determines the parameter list 506 by extracting the parameters 508 from the transaction database 122, such as directly from the transaction data 130 and/or the entity parameters 132. For example, an administrator (e.g., administrator 140) may set one or more constraints 510 that control identification of the parameters 508. The constraints 510 may include key parameters that are known to be key performance indicators, thresholds for when a parameter is important or not, etc. In embodiments, the source acquirer analyzer 126 determines the Primary Source Acquirer parameters list 506 by extracting the parameters 508 from the transaction data 130 using a statistical model. For example, the statistical model may be an exploratory data analysis (EDA). The statistical model may use one or more of univariate, bivariate, and multivariate approaches. The source acquirer analyzer 126 may process the transaction data 130 according to the EDA to identify parameters that are listed in the entity parameters 132 and/or other parameters that may not be listed.

In embodiments, the source acquirer analyzer 126 may then extrapolate and/or reduce the number of parameters 508 in the primary source acquirer parameters list 506 to generate a revised source acquirer parameters list 512. The revised source acquirer parameters list 512 may have a number of revised parameters 514(1)-514(R) that are used for generation of a segment list 516 based thereon. In embodiments, the number R of revised parameters 514 may be less than, equal to, or greater than the number M of parameters 508. For example, the source acquirer analyzer 126 may perform a Cartesian algorithm to extrapolate revised source acquirer parameters 514 that are additional to the primary parameters 508 and extrapolated from the raw data within the transaction database 122. To illustrate an example, consider the business scenario of “payments made”, where issuer parameters list 506 includes two primary parameters 508 of “spending” and “transactions”. Over a million additional parameters may be extracted from these two primary parameters 508 based on business scenarios like cross border, domestic, card present, card not present, and weekday versus weekend, approved versus declined. The extrapolation may include combining various primary parameters in combination by observing the contribution of individual parameter in the combined value. This further leads to observing the combination of combined results rather than studying a one to one impact.

The extrapolation of revised parameters may, in certain embodiments, result in too many revised parameters 514. As such, after the revised parameters 514 are extrapolated from the primary parameters 508, an iterative process may proceed to reduce the number of revised parameters 514 to a desired amount. As such, the iterative process may analyze each of the revised parameters 514 to determine its mathematical and/or business relevance to the determination of source acquirer segments 516. To determine if a parameter 508 is relevant according to business importance, the source acquirer analyzer 126 may compare the parameter 508, or the revised parameter 514, to constraints 510 (e.g., by reviewing cross border versus domestic parameters, resource present versus resource not present, etc,) to determine if the parameter 508, or the revised parameter 514, should be considered when determining the segments 516. To determine if a parameter 508, or the revised parameter 514, is relevant according to mathematical importance, the source acquirer analyzer 126 may calculate the Euclidian distance of each revised parameter 508, or parameter 514, in isolation. For example, the source acquirer analyzer 126 may determine the revised parameter 514 with the minimum 1−r2=˜ as a parameter cluster representative. The 1−r₂˜o may be defined as 1−r2=. . . =(1−r . . . , . . . :). The desired output may obtain the cluster representative to be as closely correlated to its own cluster (r0˜0.2−∓1) and as uncorrelated to the nearest cluster (r . . . ˜.0.2−∓0). Thus, the optimal representative of a cluster is a variable where 1−r2. . . tends to zero. The revised parameters 514 may be determined as the cluster representatives after the Euclidean distance of each revised parameter is calculated. If further reduction is necessary, additional mathematical and business relevancy determinations may be made in an iterative process.

Once the desired number of revised parameters 514 is obtained, the source acquirer analyzer 126 may create a segment list 516 that groups each of the source acquirers 504 into one or more different segments 518 according to their associated revised source acquirer parameters 514. In embodiments, the segments 518 are created according to a k-means learning algorithm. For example, initial centroids within the revised parameters 514 are chosen randomly. The centroid may be the mean of the points in a given cluster. The source acquirer analyzer 126 then determines closeness of each point as determined by one or more of Euclidean distance, cosine similarity, correlation, etc. The k-means clusters then converge for a common similarity measures (such as sum of squared error (SSE). The k-means convergence may be iteratively repeated until a desired convergence of segments 518 is achieved. Each segment 518 may be based on the same revised parameters 514 respectively (e.g., rankings of transactions, credit vs debit profile, customer numbers, etc.), or different ones of the revised parameters 514 may alter each segment 518 in a different way such that each segment 518 is based on different one or more of the parameters 514.

The above described functionality of the source acquirer analyzer 126 results in a plurality of segments 518(1)-518(S). These segments 518 improve the ability of the system 100 to analyze the raw data within the transaction database 122 to determine an appropriate and effective action 136 to produce to the given entity (e.g. the source acquirer 106). Once the source acquirers 504 are grouped according to the segments 518, any given source acquirer 504 can be compared to another source acquirer in the same segment 518, or in a different segment 518. This allows the source acquirer analyzer 126 to accurately compare source acquirers even if those source acquirers may be in different markets, or have different initiatives. For example, because of the segmentation described above, the source acquirer analyzer 126 may issue an action 136 for a given source acquirer 504 by comparing the given source acquirer 504 against another source acquirer 504 that is within a different geographical location (e.g. cross border initiatives).

To compare any given source acquirer in a given segment 518 (either against another source acquirer in the same segment, or another source acquirer(s) in another segment), the source acquirer analyzer 126 may use a one or more of the differentiators 522(1)-522(D) from a list of source acquirer segment differentiators 520. The differentiators 522 may be the same or different than the revised parameters 514 and/or primary parameters 508. Once the segments 518 are differentiated according to the differentiator(s) 522, the source acquirer analyzer 126 may analyze a source acquirer practice list 524, including a listing of source acquirer practices 526(1)-526(P) for each source acquirer 504, to identify practice(s) of other source acquirers that can be used to determine the action 136 to recommend to a given source acquirer. FIG. 7 depicts the source acquirer practices list 524 in further detail showing a matrix of parameters 526(1)-526(P) associated with each source acquirer 504(1)-504(N) in the source acquirer list 502. In FIG. 7, the denotation practice 526(1,1) indicates the first practice for the first source acquirer. The denotation practice 526(N,P) indicates the Pth practice for the Nth source acquirer.

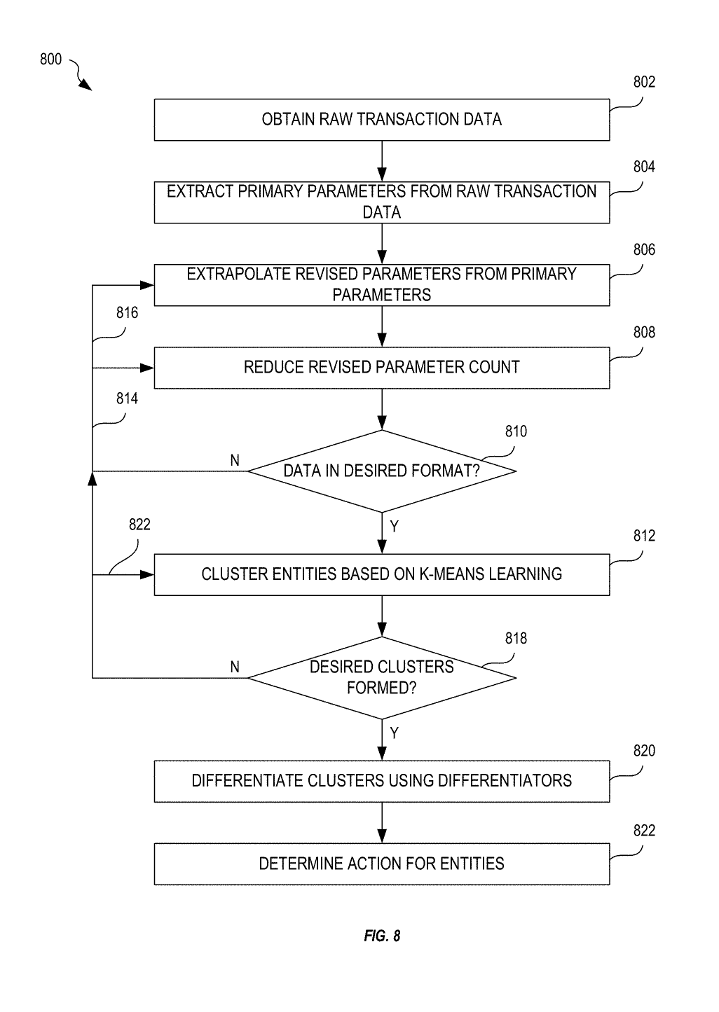

FIG. 8 depicts a method 800 for enhancing entity performance, in embodiments. Method 800 may be performed using the system 100 described above with respect to FIGS. 1-7. Method 800 may be performed to generate an action (e.g., action 136) that enhances the performance of an entity (e.g., one or more of the source acquirer 106 and the resource issuer 108).

In operation 802, the method 800 obtains raw transaction data regarding entities to which an action is to be determined. In one example of operation 802, the resource issuer analyzer 124 obtains data from the transaction database 122 regarding entities (e.g., resource issuers 108) therein. In another example of operation 802, the source acquirer analyzer 126 obtains data from the transaction database 122 regarding entities (e.g., source acquirers 106) therein.

In operation 804, the method 800 extracts primary parameters from the raw transaction data obtained in operation 802. In one example of operation 804, the resource issuer analyzer 124 extracts primary parameters 208 from the data within the transaction database 122. For example, the resource issuer analyzer 124 may perform an exploratory data analysis on the transaction database 122 to generate the primary parameters 208. In another example of operation 804, the source acquirer analyzer 126 extracts primary parameters 508 from the data within the transaction database 122. For example, the source acquirer analyzer 126 may perform an exploratory data analysis on the transaction database 122 to generate the primary parameters 508.

In operation 806, the method 800 extrapolates revised parameters in addition to the primary parameters from the raw transaction data. In one example of operation 806, the resource issuer analyzer 124 extrapolates additional revised parameters 214. For example, the resource issuer analyzer 124 may perform a Cartesian algorithm to extrapolate revised parameters 214. In another example of operation 806, the source acquirer analyzer 126 extrapolates additional revised parameters 514. For example, the source acquirer analyzer 126 may perform a Cartesian algorithm to extrapolate revised parameters 514.

In operation 808, the method 800 reduces the number of revised parameters. In one example of operation 808, the resource issuer analyzer 124 reduces the number of revised parameters 214 based on their respective mathematical and/or business importance. For example, the resource issuer analyzer 124 may determine if a revised parameter 214 is business important by comparing the parameter 214 to constraints 210. As another example, the resource issuer analyzer 124 may determine if a revised parameter 214 is mathematically important by calculating the Euclidean distance of the parameter in isolation, as discussed above. In another example of operation 808, the source acquirer analyzer 126 reduces the number of revised parameters 514 based on their respective mathematical and/or business importance. For example, the source acquirer analyzer 126 may determine if a revised parameter 514 is business important by comparing the parameter 514 to constraints 510. As another example, the source acquirer analyzer 126 may determine if a revised parameter 514 is mathematically important by calculating the Euclidean distance of the parameter in isolation, as discussed above.

Operation 810 is a decision. In operation 810, the method 800 determines if the revised parameters are in a desired format (e.g., if the revised parameters are sufficiently reduced). If so, the method 800 proceeds to operation 812, else the method repeats operation 808 as indicated by arrow 814, or operation 806 as indicated by arrow 816.

In operation 812, the method 800 clusters entities based on k-means learning and the revised parameters. In one example of operation 812, the resource issuer analyzer 124 clusters resource issuers 204 into segments 218 using a k-means algorithm as discussed above. In another example of operation 812, the source acquirer analyzer 126 clusters entities 504 into segments 518 using a k-means algorithm as discussed above.

Operation 818 is a decision. In operation 818, the method 800 determines if the entities are clustered in a desired format. If so, then method 800 proceeds with operation 820. Else, method 800 repeats operation 812 as indicated by line 822, operation 808 as indicated by arrow 814, or operation 806 as indicated by arrow 816.

In operation 820, the segments formed in operation 812 are differentiated. In one example of operation 820, the resource issuer analyzer 124 differentiates each segment according to differentiators 222. In another example of operation 820, the source acquirer analyzer 126 differentiates each segment according to differentiators 522.

In operation 822, an action is generated according to the differentiated segments of operation 820. In one example of operation 820, the resource issuer analyzer 124 analyzes issuer practices 226 of an issuer against other issuers in the same segment, or a different segment to generate action 136 and produce the action 136 to the given resource issuer 108. In another example of operation 820, the source acquirer analyzer 126 analyzes source acquirer practices 526 of a source acquirer against other source acquirers in the same segment, or a different segment to generate action 136 and produce the action 136 to the given source acquirer 106.

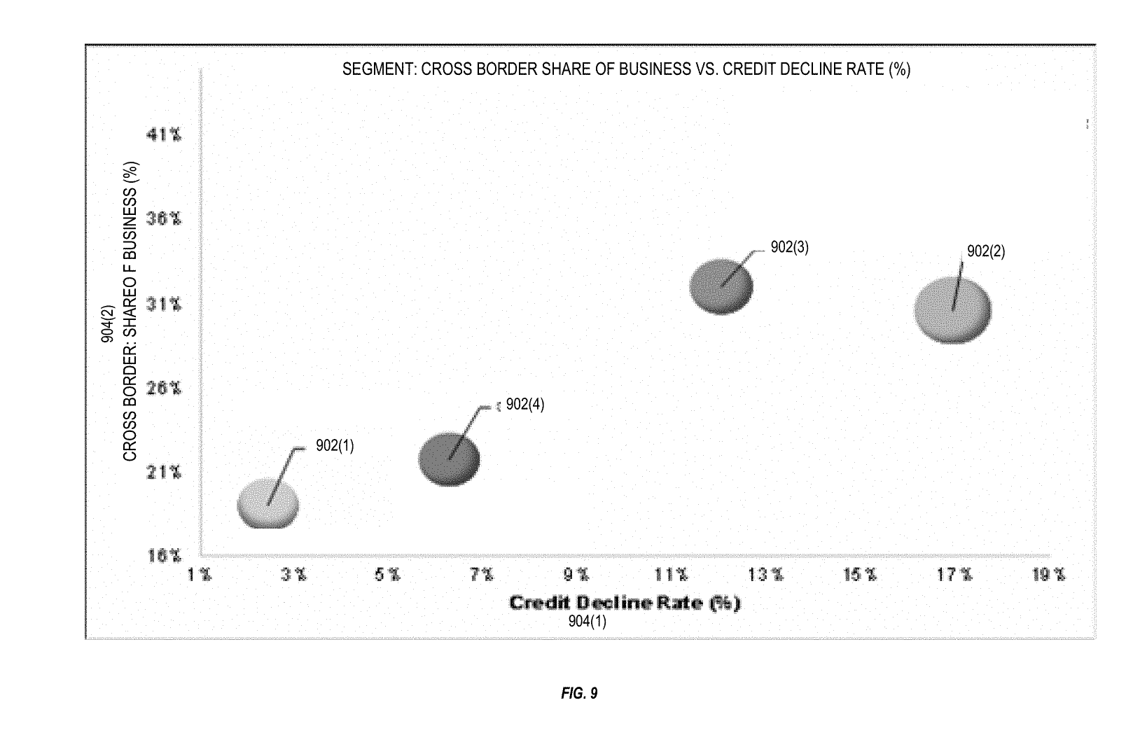

FIG. 9 depicts a graph 900 of four example segments 902 that are differentiated according to two differentiators 904, in an embodiment. The segments 902(1)-902(4) consists of issuers that are segmented based on the following parameters. Segment 902(1): “Big Banks” consisting of seventeen issuers having (a) highest credit portfolio share, (b) lowest cross border decline rate, (c) highest cross border ticket size, and (d) most diverse consumer products penetration. Segment 902(2): “Midsized Banks” consisting of twenty seven issuers having (a) a credit/debit mix, (b) highest average ticket, (c) highest cross border decline rate, and (d) highest ecommerce percentage. Segment 902(3): “Card Issuers and Payment Solutions Banks” consisting of eighteen issuers having (a) a credit/pre-paid mix, (b) highest prepaid portfolio share, (c) lowest cross border volume, and (d) lowest average GDV per issuer. Segment 902(4): “Debit” consisting of seventeen issuers having (a) the highest debit portfolio share, (b) lowest cross border performance, (c) Maestro® focus, and (d) lowest average GDV per issuer.

The segments 902 are examples of segments 218. The segments 902 are then differentiated by a first differentiator 904(1) of credit decline rate percentage (x-axis), and a second differentiator 904(2) of cross border: share of business percentage. Differentiators 904 are examples of differentiators 222.

It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A system for enhancing entity performance, comprising:
a resource manager in communication with a plurality of entities, the entities including one or more source acquirers and one or more resource issuers,
the resource manager including:
a processor, and
a memory storing an analyzer having computer readable instructions that, when executed by the processor, operate to perform the following steps:
organize the plurality of entities into a plurality of segments based on one or more parameters of the plurality of entities,
differentiate each segment from other segments based on one or more differentiators,
compare practices of an entity within a given segment to identify an action to enhance performance of the entity, and
communicate the action to the entity.

2. The system of claim 1, the analyzer being a resource issue analyzer.

3. The system of claim 1, the analyzer being a source acquirer analyzer.

4. The system of claim 1, the differentiators being different from the parameters.

5. The system of claim 1, at least one of the differentiators being the same as at least one of the parameters.

6. The system of claim 1, the step of organizing the plurality of entities into a plurality of segments including the sub-steps of:
obtaining transaction data from a transaction database to identify the plurality of entities,
extracting primary parameters associated with the entities,
extrapolating revised parameters from the transaction data and in addition to the primary parameters.

7. The system of claim 6, the step of extracting primary parameters associated with the entities including performing an exploratory data analysis algorithm.

8. The system of claim 6, the extrapolating revised parameters from the transaction data and in addition to the primary parameters including performing a Cartesian algorithm.

9. The system of claim 6, the step of organizing the plurality of entities into a plurality of segments further including reducing the revised parameter count.

10. The system of claim 9, the step of reducing the revised parameter count including iteratively determining the Euclidean distance of each revised parameter until a desired number of parameters is determined.

11. The system of claim 9, the step of reducing the revised parameter count including comparing each revised parameter to at least one constraint as defined by administrator interaction with the analyzer.

12. A method for enhancing entity performance, comprising:
extracting a plurality of primary parameters from transaction data associated with a plurality of entities;
extrapolating revised parameters from the transaction data in addition to the primary parameters;
organizing the plurality of entities into a plurality of segments based on the revised parameters;
differentiating each segment from other segments based on one or more differentiators;
comparing practices of an entity within a given segment to identify an action to enhance performance of the entity; and
communicating the action to the entity.

13. The method of claim 12, the extracting primary parameters including performing an exploratory data analysis algorithm.

14. The method of claim 12, the extrapolating revised parameters from the transaction data and in addition to the primary parameters including performing a Cartesian algorithm.

15. The method of claim 12, further including reducing the revised parameter count.

16. The method of claim 15, the reducing the revised parameter count including iteratively determining the Euclidean distance of each revised parameter until a desired number of parameters is determined.

17. The method of claim 15, the reducing the revised parameter count including comparing each revised parameter to at least one constraint as defined by administrator interaction with the analyzer.

18. A non-transitory computer readable medium comprising computer executable instructions stored thereon executed by a processor to enhance performance of an entity, the instructions controlling the processor to:
extract a plurality of primary parameters from transaction data associated with a plurality of entities;
extrapolate revised parameters from the transaction data in addition to the primary parameters;
iteratively reduce the revised parameters until a desired number of revised parameters is obtained;
organize the plurality of entities into a plurality of segments based on the revised parameters;
differentiate each segment from other segments based on one or more differentiators;
compare practices of an entity within a given segment to identify an action to enhance performance of the entity; and
communicate the action to the entity.

19. The non-transitory computer readable medium of claim 18, the iteratively reduce the revised parameter count including instructions to iteratively determine the Euclidean distance of each revised parameter.

20. The non-transitory computer readable medium of claim 18, the iteratively reduce the revised parameter count including instructions to compare each revised parameter to at least one constraint as defined by administrator interaction with the analyzer.
